(19) United States
(12) Patent Application Publication
(10) Pub. No.: US 2007/0242081 A1
(43) Pub. Date: Oct. 18, 2007

(54) Method and apparatus for interpolating color value

(75) Inventors: Young-hoon Jeong, Suwon-si (KR); Ju-hee Park, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/708,628

(22) Filed: Feb. 21, 2007

(30) Foreign Application Priority Data
Apr. 18, 2006 (KR) 10-2006-0035067

(51) Int. Cl. G09G 5/02

(52) U.S. Cl. 345/606

(57) ABSTRACT

A method and apparatus are provided for receiving a color signal detected by a single chip image sensor which detects only a single one of a plurality of color components and for interpolating a color component that cannot be detected in each pixel. The apparatus determines information horizontal and vertical edges around a current interpolating pixel using data on a green color value and interpolates a color value that cannot be detected in the current pixel in a horizontal or vertical direction, depending on the determined interpolating direction.

### CROSS-REFERENCE TO RELATED PATENT APPLICATION

This application claims the benefit of Korean Patent Application No. 10-2006-0035067, filed on Apr. 18, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relate to interpolating a color value, and more particularly, to interpolating a color value, by which information about color signals detected by a single chip image sensor which detects only a single one of a plurality of color components is received so as to interpolate a color value that cannot be detected in each pixel.

2. Related Art

Generally, a digital camera or a camcorder has image sensors such as a charge coupled device (CCD) or a complementary metal oxide semiconductor (CMOS) sensor. Since such image sensors detect light intensity, the image obtained using the sensor is not a color image, but is a monochrome image. Therefore, a color filter array (CFA) capable of transmitting red (R), green (G), and blue (B) color components is provided in each pixel of the sensor in order to obtain the color image, and each pixel of the sensor detects the intensities of the R, G and B color signals transmitted through the CFA. Since the RGB color format corresponds to three primary colors of light and has a wavelength band to which the cone cells of a human eye respond, it is used in the related art to obtain a high quality image.

Although three CCDs or CMOS sensors for detecting RGB color information are used in broadcast units or the like, a single chip CCD or CMOS sensor is used in order to reduce cost. Since color information corresponding to only one of a plurality of channels is stored in each pixel of the single chip sensor, the color information of other channels is not stored in each pixel and should be restored from color information of neighboring pixels to obtain a perfect image. This process of restoring the color information is called color interpolation or de-mosaicing.

FIG. 1 is a pixel diagram illustrating a related art Bayer color filter array (CFA), as disclosed in U.S. Pat. No. 3,971,065. In FIG. 1, it is assumed that the square corresponds to a single pixel of the image sensor, and the reference numeral ab denotes a pixel located in the ath row and bth column (a, b). For example, the reference numeral B33 denotes a blue (B) color value of a pixel (3, 3) located in the third row and the third column. As shown in FIG. 1, since the single chip image sensor such as the Bayer CFA detects only a single color value in each pixel, it is required to interpolate the color value that cannot be detected in each pixel on the basis of the color values detected by the neighboring sensors.

Related art color interpolation algorithms do not appropriately utilize information of neighboring pixels when the color values are interpolated in an edge direction. Therefore, color errors may occur in high frequency or edge image portions.

### SUMMARY OF THE INVENTION

The present invention provide a method and apparatus for interpolating a color value, by which the color value that cannot be detected in the current pixel is more accurately interpolated on the basis of information about neighboring areas of the current pixel, and thus color errors usually generated in edge regions can be prevented.

According to an aspect of the present invention, there is provided a method of interpolating, a color component that cannot be detected among a plurality of color components of each pixel, the method comprising: calculating an edge strength of a current pixel on the basis of differences of color values between the current pixel and neighboring pixels; calculating a horizontal color value difference and a vertical color value difference of the current pixel on the basis of differences of color values detected in the neighboring pixels arranged in the same row and column as those of the current pixel; determining an interpolating direction of a color value that cannot be detected in the current pixel on the basis of the calculated edge strength of the current pixel and horizontal and vertical color value differences of the current pixel and previously processed pixels; and interpolating the color value that cannot be detected in the current pixel in the determined interpolating direction using the neighboring pixels around the current pixel.

According to another aspect of the present invention, there is provided a method of interpolating a color component that cannot be detected among a plurality of color components of each pixel, the method comprising: generating a horizontal color interpolation candidate value and a vertical color interpolation candidate value by interpolating a color value that cannot be detected in a current pixel by using neighboring pixels arranged in horizontal and vertical directions of the current pixel; calculating an edge strength of the current pixel on the basis of differences of color values between the current pixel and the neighboring pixels; calculating a horizontal color value difference and a vertical color value difference of the current pixel on the basis of differences of color values detected in the neighboring pixels arranged in the same row and column as those of the current pixel; determining an interpolating direction of a color value that cannot be detected in the current pixel on the basis of the calculated edge strength of the current pixel and horizontal and vertical color value differences of the current pixel and previously processed pixels; and selecting a color interpolation candidate value interpolated in the determined interpolating direction from the horizontal and vertical color interpolation candidate values as an interpolation value of the color that cannot be detected in the current pixel.

According to another aspect of the present invention, there is provided an apparatus for interpolating a color component that cannot be detected among a plurality of color components of each pixel, the apparatus comprising: an edge strength calculation unit calculating an edge strength of a current pixel on the basis of differences of color values between the current pixel and neighboring pixels around the current pixel; a direction calculation unit calculating a horizontal color value difference and a vertical color value difference of the current pixel on the basis of the differences of color values detected in the pixels arranged in the same row and column as those of the current pixel; an interpolating direction determination unit determining an interpolating direction of the color value that cannot be detected in the current pixel on the basis of the calculated edge strength of the current pixel and the horizontal and vertical color value differences of the current pixel and previously processed pixels; and an interpolation unit interpolating the color value that cannot be detected in the current pixel in the determined interpolating direction using the neighboring pixels around the current pixel.

According to another aspect of the present invention, there is provided an apparatus for interpolating a color component that cannot be detected among a plurality of color components of each pixel, the apparatus comprising: a color interpolation candidate value generation unit generating a horizontal color interpolation candidate value and a vertical color interpolation candidate value by interpolating a color value that cannot be detected in a current pixel by using neighboring pixels arranged in horizontal and vertical directions of the current pixel; an edge strength calculation unit calculating an edge strength of the current pixel on the basis of differences of color values between the current pixel and the neighboring pixels; a calculation unit calculating a horizontal color value difference and a vertical color value difference of the current pixel on the basis of differences of color values detected in the neighboring pixels arranged in the same row and column as those of the current pixel; an interpolating direction determination unit determining an interpolating direction of the color value that cannot be detected in the current pixel on the basis of the calculated edge strength of the current pixel and horizontal and vertical color value differences of the current pixel and previously processed pixels; and a selection unit selecting a color interpolation candidate value interpolated in the determined interpolating direction in the horizontal and vertical color interpolation candidate values as an interpolation value of the color that cannot be detected in the current pixel.

### BRIEF DESCRIPTION OF THE DRAWINGS

The above and other aspects of the present invention will become more apparent by describing in detail exemplary embodiments thereof with reference to the attached drawings in which:

FIG. 1 is a pixel diagram illustrating a related art Bayer color filter array;

FIG. 2 is a block diagram schematically illustrating a photographic device having a color interpolation apparatus according to an exemplary embodiment of the present invention;

FIG. 3 is a block diagram illustrating a color interpolation apparatus according to an exemplary embodiment of the present invention;

FIG. 4 is a flowchart illustrating a color interpolation method according to an exemplary embodiment of the present invention;

FIG. 5 is a pixel diagram for describing a process of calculating an edge strength of a current pixel according to an exemplary embodiment of the present invention;

FIG. 6 is a graph for describing a process of determining a weighting factor a which is inversely proportional to an edge strength according to an exemplary embodiment of the present invention;

FIG. 7 is a pixel diagram for describing a process of calculating a horizontal color value difference and a vertical color value difference according to an exemplary embodiment of the present invention;

FIGS. 8A and 8B are pixel diagrams for describing a process of applying a horizontal color value difference ΔH and a vertical color value difference ΔV of a neighboring pixel in order to determine an interpolation direction according to an exemplary embodiment of the present invention;

FIGS. 9A to 9E are pixel diagrams illustrating a process of interpolating a color value which is not detected in a current pixel when the current pixel detects a red color value R;

FIGS. 10A to 10E are pixel diagrams illustrating a process of interpolating red and blue color values R and B which is not detected in a current pixel when the current pixel detects a green color value G;

FIG. 11 is a block diagram illustrating a color interpolation apparatus according to another exemplary embodiment of the present invention;

FIG. 12 is a flowchart illustrating a color interpolation method according to another exemplary embodiment of the present invention; and

FIGS. 13A and 13B are photographs for comparing an image interpolated by a color interpolation method according to an exemplary embodiment of the present invention with an image interpolated by a color interpolation method according to the related art.

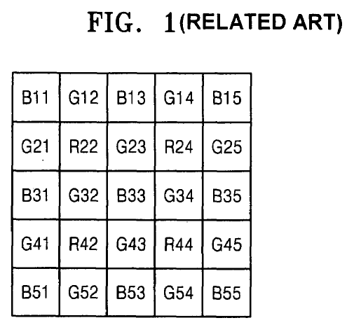

### DETAILED DESCRIPTION OF THE EXEMPLARY EMBODIMENTS

Hereinafter, exemplary embodiments of the present invention will be described with reference to the accompanying drawings. Although the present invention will be described by exemplifying an RGB color format, it can be readily recognized by a person of ordinary skill in the art that other color formats such as a CMYG color format or a YCbCr color format may also be used without departing from the scope of the present invention.

In the exemplary embodiments, the term “unit” is used to describe various features and aspects. The term “unit” is defined as understood by those skilled in the art, and may be used interchangeably with the structure of a “circuit” in the case of hardware, and with the structure of a computer-readable medium in the case of software. Further, a unit may also be a hardware-software combination. However, the exemplary embodiments are not limited to these structures, and other structures as envisioned by one skilled in the art may be used for a “unit” without departing from the scope of the present invention.

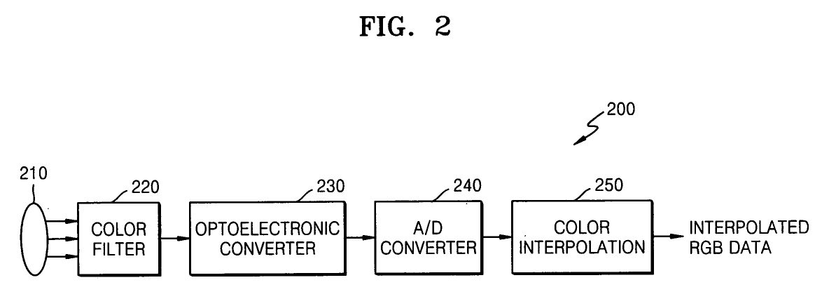

FIG. 2 is a block diagram schematically illustrating a photographic device 200 having an apparatus for interpolating a color value according to an exemplary embodiment of the present invention. An image of an object is input through the lens 210 and transmitted to an optoelectronic converter unit 230 through a color filter 220. The optoelectronic converter unit 230 may include a single chip CCD or CMOS sensor. The color filter 220 may include an RGB color filter in which filters capable of transmitting RGB color components are arranged in a cross shape or a CMYG color filter, and in which filters capable of transmitting cyan, magenta, yellow, and green (CMYG) color components are arranged in a cross shape. The analog-to-digital (A/D) converter unit 240 converts analog image signals output from the optoelectronic converter unit 230 into digital signals. The color interpolation unit 250 interpolates color information of other channels, which is not stored in each pixel, on the basis of color information of neighboring pixels using the digital signals to output the interpolated RGB data. It can be recognized that the apparatus for interpolating a color value according to an exemplary embodiment of the present invention corresponds to the color interpolation unit 250.

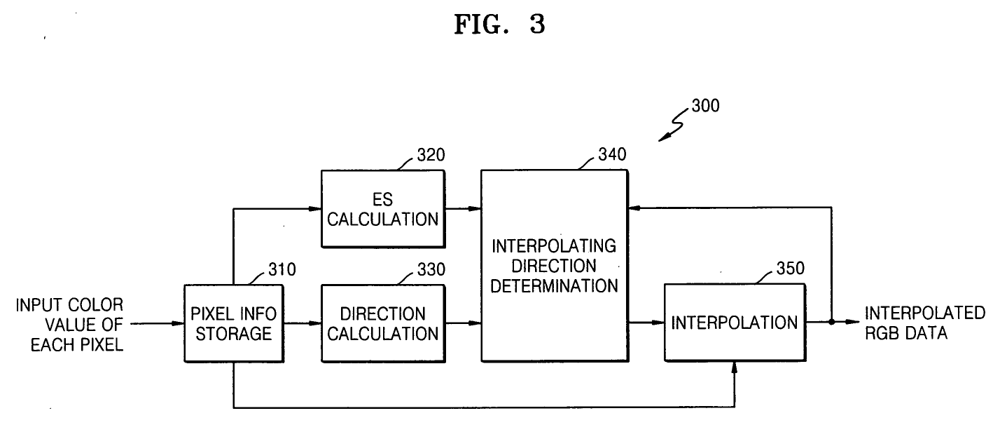

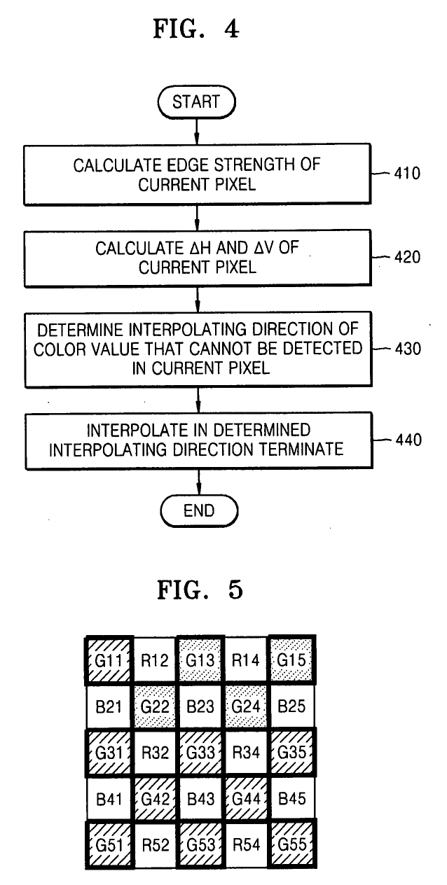

FIG. 3 is a block diagram illustrating an apparatus for interpolating a color value according to an exemplary embodiment of the present invention, and FIG. 4 is a flowchart of a method of interpolating a color value according to an exemplary embodiment of the present invention.

The apparatus for interpolating the color value according to the exemplary embodiment determines information on horizontal and vertical edges surrounding a current interpolating pixel on the basis of G color data which is considered to be similar to a luminance component of the RGB data, and interpolates the color value that cannot be detected in the current pixel in a horizontal or vertical direction depending on the determined interpolating direction. Hereinafter, a method and apparatus for interpolating a color value according to the exemplary embodiment of the present invention will be described with reference to the accompanying drawings.

Referring to FIG. 3, the apparatus 300 for interpolating a color value includes a pixel information storage unit 310, an edge strength calculation unit 320, a direction calculation unit 330, an interpolating direction determination unit 340, and an interpolation unit 350.

The pixel information storage unit 310 stores the color values input from each pixel of the CFA. The pixel information storage unit 310 stores the color value of the current pixel and the color values detected from neighboring pixels.

The edge strength calculation unit 320 calculates an edge strength on the basis of differences of color values between the current pixel and neighboring pixels, and determines whether there is an edge region around the current pixel (operation 410). If there is an edge region in the image, the color values of each half of the pixel regions divided with respect to the edge are different from each other. To determine whether the current pixel is included in the edge region, differences of color values between the current pixel and the neighboring pixels are calculated to obtain the edge strength ES. Optionally, the color value of the G channel of the RGB color channel may be used when the ES is calculated because the G channel is substantially similar to the luminance component of the image, and the R and B channels are substantially similar to the chrominance component of the image. Therefore, whether there is an edge region around the current pixel can be determined using the color value of the G channel.

FIG. 5 is a pixel diagram for describing a process of calculating an ES around the current pixel according to an exemplary embodiment of the present invention. In FIG. 5, the alphabetic character denotes the color component detected in each pixel, and the numerical characters denote a location of each pixel. For example, G12 denotes a green color value detected from the pixel (1, 2) located in the first row and the second column.

Assuming that the location of the current pixel is (3, 3), to determine whether there is an edge region around the current pixel, the ES can be calculated as follows:

$$ES = F 1 \times \vert G 33 - G 22 \vert + F 2 \times \vert G 33 - G 24 \vert + F 3 \times \vert G 33 - G 42 \vert + F 4 \times \vert G 33 - G 44 \vert + F 5 \times \vert G 33 - G 15 \vert + F 6 \times \vert G 33 - G 13 \vert + F 7 \times \vert G 33 - G 11 \vert + … . \qquad [ Equation 1 ]$$

As shown in Equation 1, the ES can be calculated using a weighted sum obtained by multiplying a weighting factor by differences of the G color values between the current pixel and the neighboring pixels. In Equation 1, F1 to F7 denote weighting factors applied to each pixel. Different weighting factors may be applied depending on a distance from the current interpolating pixel. For example, a relatively large weighting factor may be applied to the near pixels G22, G24, G42, and G44, and a relatively small weighting factor may be applied to the pixels G15, G13, G11, G31, G51, G53, G55, and G35 which are far from the current pixel.

As shown in FIG. 5, the ES can be calculated with respect to the current pixel according to Equation 1 when the current pixel detects the G color value. When the current pixel detects an R or B color value, at least one of the ESs calculated for the neighboring pixels or for all or a selected portion of the ESs calculated for the neighboring pixels may be used. For example, if the color value R34 is detected from the current pixel (3, 4), one of edge strengths calculated according to Equation 1 for the neighboring pixels G24, G33, G44 and G35 may be directly used as the ES of the pixel R34, or an average of the ESs of all or a selected portion of the neighboring pixels G24, G33, G44 and G35 may be used as the ES of the pixel R34. In other words, an ES calculated for one of the neighboring pixels G24, G33, G44 and G35 or an average (G24+G33+G44+G35)/4 of their ESs may be used as the edge strength of the pixel R34.

On the other hand, color errors may occur in the edge region when the color interpolation is performed, because the R and B color values may not be accurately interpolated. Accordingly, the color errors may be reduced by interpolating the R and B color values in a similar way to that of the G color value. For this purpose, according to an exemplary embodiment of the present invention, if the current interpolating pixel is a G pixel which detects the G color value, a weighting factor a is multiplied to the R and B color values so as to be inversely proportional to the ES as shown in FIG. 6 when the R and B color values that cannot not detected in the current pixel are interpolated. As a result, the R and B color values can be approximated to the G color value in a region having a high ES, while the R, G and B color values can be interpolated independently of one another in a region having a low ES. In other words, if the ES of the current pixel is a relatively large value A, a weighting factor A′ corresponding to the ES A is used when the R or B color value is interpolated by using a function 60. If the ES of the current pixel is a relatively small value B, a weighting factor B′ corresponding to the ES B is used when the R or B color value is interpolated by using the function 60.

The function 60 is not limited to that shown in the drawing, and other functions that can output a value, which is inversely proportional to the ES, may be used as necessary. Otherwise, a look-up table may be used so as to output a weighting factor depending on the ES.

Referring to FIGS. 3 and 4, the direction calculation unit 320 calculates a horizontal color value difference ΔH and a vertical color value difference ΔV using differences of color values detected in the pixels arranged in the same row and column as those of the current pixel (operation 420). This process is performed to select an interpolating direction from the horizontal and vertical directions by inspecting which of the horizontal and vertical directions has a stronger edge characteristic for the neighboring pixels around the current pixel.

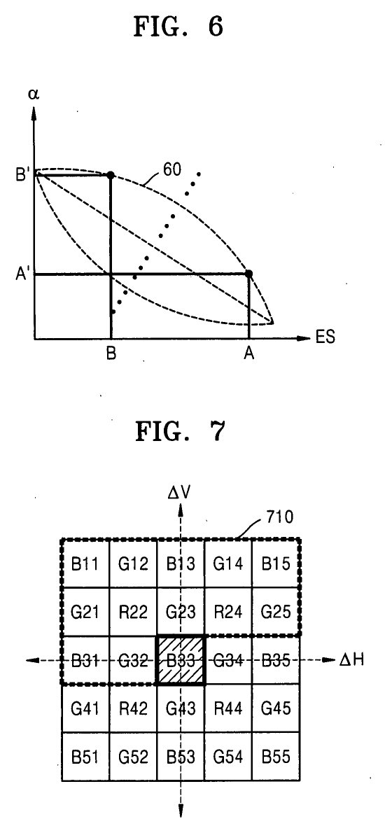

FIG. 7 is a pixel diagram for describing a process of calculating a horizontal color value difference and a vertical color value difference according to an exemplary embodiment of the present invention. It is assumed that a color value B33 is detected from the current interpolating pixel (3, 3).

The horizontal color value difference ΔH and the vertical color value difference ΔV of the current pixel are calculated as follows:

ΔH=|G22−G34|+|(B33−B31)+(B33−B35)|

ΔV=|G23−G43|+|(B33−B13)+(B33−B53)| [Equation 2]

If the horizontal color value difference ΔH is larger than the vertical color value difference ΔV (i.e., ΔH>ΔV) in Equation 2, it means that the ESs of the neighboring pixels arranged in a vertical direction around the current pixel is stronger. On the contrary, if the horizontal color value difference ΔH is smaller than the vertical color value difference ΔV (ΔH<ΔV), it,means that the ESs of the neighboring pixels arranged in a horizontal direction around the current interpolating pixel are stronger. Although differences between the current pixel and the neighboring pixels included in a 5×5 mask are calculated in Equation 2, the number of neighboring pixels required to calculate the horizontal and vertical color value differences ΔH and ΔV may be changed.

The interpolating direction determination unit 340 determines an interpolating direction of the color value that cannot be detected in the current pixel based on the ES calculated by the edge strength calculation unit 320 for the current pixel and the horizontal and vertical color value differences ΔH and ΔV calculated by the direction calculation unit 330 for the current pixel and the previously interpolated neighboring pixels (operation 430).

The interpolating direction determination unit 340 determines that the region around the current pixel is a substantially flat area having no large difference between the pixel values when the ES of the current pixel is equal to or smaller than a threshold value Th1, so that the interpolating direction is determined only on the basis of the horizontal and vertical color value differences ΔH and ΔV calculated for the current pixel. The interpolating direction determination unit 340 determines the interpolating direction of the color value that cannot be detected from the current pixel as a vertical direction when the ES of the current pixel is smaller than the threshold value (ES<Th1), and the horizontal color value difference ΔH is larger than the vertical color value difference ΔV (i.e., ΔH>ΔV). The interpolating direction determination unit 340 determines the interpolating direction of the color value that cannot be detected from the current pixel as a horizontal direction when the ES of the current pixel is smaller than the threshold value (ES<Th1), and the horizontal color value difference ΔH is smaller than the vertical color value difference ΔV (i.e., ΔH<ΔV).

When the ES of the current pixel is larger than the threshold value Th1 (ES>Th1), a probability that an edge exists around the current pixel is high. Therefore, the interpolating direction determination unit 340 determines the interpolating direction based on the horizontal and vertical color value differences ΔH and ΔV calculated for the neighboring pixels as well as for the current pixel. Therefore, directionality of the edges in the neighboring pixels determine the edge direction when a stronger edge component is included in the current pixel.

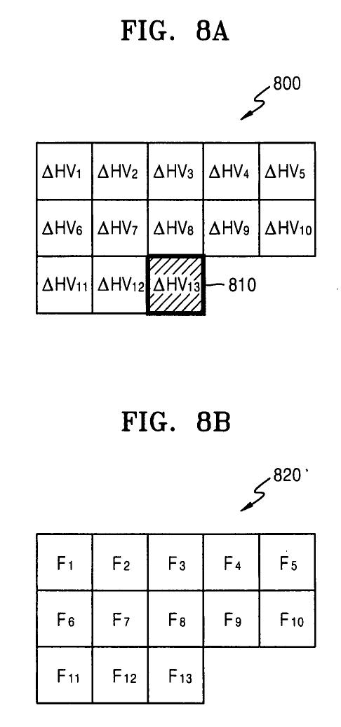

FIGS. 8A and 8B are pixel diagrams for describing a process of using the horizontal and vertical color value differences ΔH and ΔV of the neighboring pixel in order to determine the interpolating direction according to an exemplary embodiment.

The interpolating direction determination unit 340 calculates the difference ΔH−ΔV for each of the pixels processed before the current pixel 810 by subtracting the vertical color value difference ΔV from the horizontal color value difference ΔH when the ES of the current pixel is larger than the threshold value Th1 (ES>Th1). In addition, the interpolating direction determination unit 340 counts the number N of neighboring pixels having a positive difference ΔH−ΔV and compares N with a threshold value Th2. When N is equal to or larger than the threshold value Th2, the interpolating direction of the color value that has not be detected in the current pixel is determined as a vertical direction in order to interpolate the current pixel in a substantially similar direction to those of the neighboring pixels if there is a high probability that the neighboring pixels are selected in a constant direction when the previous pixels are processed.

If N is equal to or smaller than the threshold value Th2, the interpolating direction determination unit 340 may determine the interpolating direction of the color value that cannot be detected from the current pixel as a horizontal direction. Otherwise, the interpolating direction determination unit 340 may additionally perform a spatial filtering for the differences ΔH−ΔV of the current pixel and each of the neighboring pixels and determine the interpolating direction of the color value that cannot be detected in the current pixel on the basis of the value obtained by the spatial filtering.

For example, assuming that ΔHVi denotes the value obtained by subtracting the vertical color value difference ΔV from the horizontal color value difference ΔH at the ith pixel location (i.e., ΔHVi=ΔHi−ΔVi) in FIG. 8A, and Fi denotes a filtering coefficient at the ith pixel location in FIG. 8B, the filtered value obtained by the spatial filtering can be calculated as follows:

$$Filtered\_value = {\sum }_{i = 1}^{13} ( Δ {HV}_{i} \times {F}_{i} ) \qquad [ Equation 3 ]$$

Assuming that n denotes the number of the current pixel and the neighboring pixels, and the filtering coefficient Fi is 1/n, the filtered value is an average of the differences ΔHi−ΔVi calculated for the current pixel and all of the neighboring pixels. In addition, if

$${\sum }_{i = 1}^{13} {F}_{i} = 1.0 ,$$

and a relatively large filtering coefficient is set for the neighboring pixels around the current pixel, the filtered value has a low-pass filtering characteristic. For example, when the filtering coefficients F1, F2, F4, F5, F6, F10 and F11 are set to 0.05, the filtering coefficients F3, F7, F8, F9 and F12 are set to 0.1, and the filtering coefficient F13 is set to 0.15, the filtered value calculated on the basis of Equation 3 has a low-pass filtering characteristic.

The interpolating direction determination unit 340 may determine directionality of edges in the neighboring pixels using the filtered value, and select the interpolating direction of the color value that cannot be detected from the current value on the basis of the result of the determination.

Referring to FIGS. 3 and 4, the interpolation unit 350 performs interpolation using the neighboring pixels around the current pixel in the interpolating direction determined by the interpolating direction determination unit 340 (operation 440)

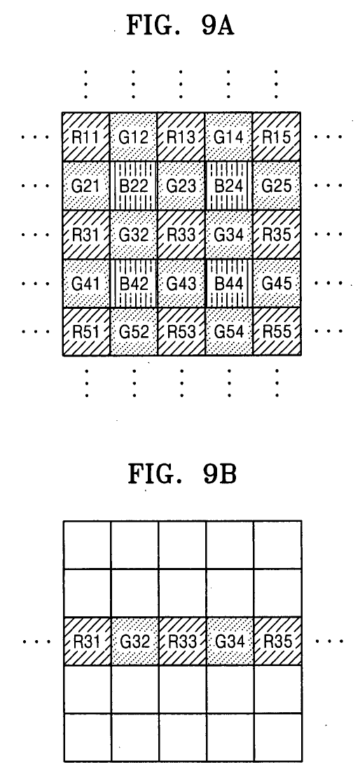

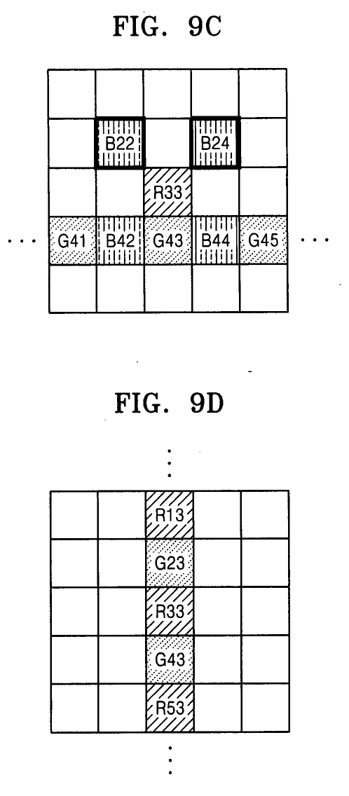

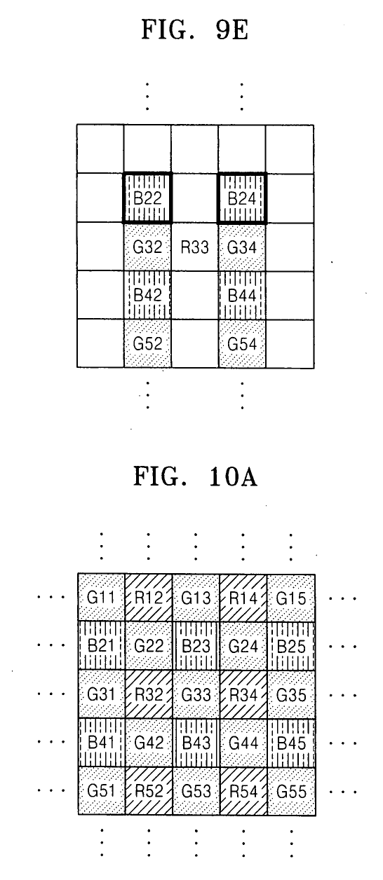

FIGS. 9A to 9E are pixel diagrams describing a process of interpolating a color value that cannot be detected in the current pixel when the current pixel detects an R color value. Although FIGS. 9A to 9E assume that the current pixel is an R pixel which detects the R color value, the following interpolation method can be similarly applied to a case where the current pixel is a B pixel which detects the B color value.

Referring to FIG. 9A, if the current pixel (3, 3) is an R pixel which detects only the R color value R33, the G and B color values G33 and B33 that cannot be detected in the current pixel are interpolated using the neighboring pixels in one of the horizontal and vertical directions depending on the interpolating direction determined by the interpolating direction determination unit 340.

When the interpolating direction determined by the interpolating direction determination unit 340 is the horizontal direction, the G color value G33 of the current pixel can be calculated as follows:

G33=(G32+G34)/2+{(R33−R31)+(R33−R35)}/4 [Equation 4]

Referring to Equation 4 and FIG. 9B, if the current pixel (3, 3) is an R pixel which detects the R color value R33, the G color value G33 of the current pixel (3, 3) can be calculated by adding an average of the G color values G32 and G34 detected in the neighboring pixels (3, 2) and (3, 4) located in the same row as that of the current pixel (3, 3) and an average of the differences between the color values detected in the current pixel and color values R31 and R35 detected in the neighboring pixels (3, 1) and (3, 5) of the same components (e.g., the R component).

The B color value B33 of the current pixel can be calculated as follows:

B33=G33+{(B22−G22)+(B24−G24)+(B42−G42)+(B44−G44)}/4 [Equation 5]

Referring to Equation 5 and FIG. 9C, the B color value B33 of the current pixel is calculated by adding the G color value G33 of the current pixel to an average of the differences between the B color values B22, B24, B42, and B44 detected in four neighboring pixels located in the diagonal directions of the current pixel and the G color values G22, G24, G42 and G44 interpolated for the four neighboring pixels located in the diagonal directions. In this case, the G color values G22, G24, G42 and G44 of the B pixels located in the diagonal directions may be calculated by averaging the G color values of the pixels located in the same row as the determined horizontal interpolating direction. For example, in FIG. 9C, the G color value G42 of the pixel (4, 2) can be calculated according to a formula (G41+G43)/2, and the G color value G44 of the pixel (4, 4) may be calculated according to a formula (G43+G45)/2.

When the interpolating direction determined by the interpolating direction determination unit 340 is a vertical direction, the G color value G33 of the current pixel (3, 3) can be calculated as follows:

G33=(G23+G43)/2+{(R33−R13)+(R33−R53)}/4 [Equation 6]

Referring to Equation 6 and FIG. 9D, if the current pixel is an R pixel which detects the R color value R33, the G color value G33 of the current pixel (3, 3) can be calculated by adding an average of the G color values G23 and G43 detected in the neighboring pixels located in the same column as that of the current pixel (3, 3) to an average of the differences between the color value R33 detected in the current pixel and the color values R13 and R53 of the same color components detected in the neighboring pixels (1, 3) and (5, 3).

Referring to Equation 5 and FIG. 9E, the B color value B33 of the current pixel (3, 3) is calculated by adding the interpolated G color value G33 of the current pixel (3, 3) to an average of differences between the B color values B22, B24, B42 and B44 detected in four neighboring pixels located in diagonal directions of the current pixel and the G color values G22, G24, G42, and G44 interpolated for the four neighboring pixels. In this case, the G color values G22, G24, G42, and G44 of the neighboring B pixels located in diagonal directions may be calculated by averaging the G color values of the pixels located in the same column as the determined vertical interpolating direction. For example, in FIG. 9E, the G color value G42 of the pixel (4, 2) may be calculated using a formula (G32+G52)/2, and the G color value G44 of the pixel (4, 4) may be calculated using a formula (G34+G54)/2.

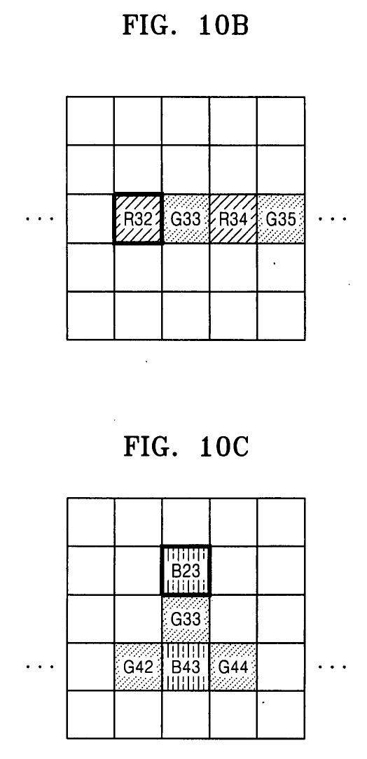

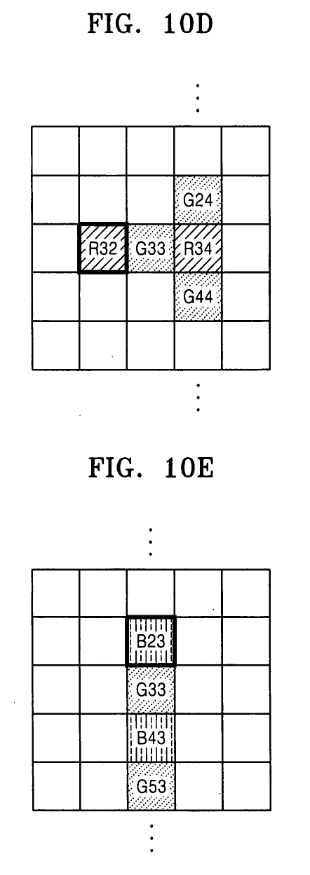

FIGS. 10A to 10E are pixel diagrams for describing a process of interpolating R and B color values that cannot be detected in the current pixel when the current pixel detects a G color value.

Referring to FIG. 10A, when the current pixel (3, 3) is a G pixel which detects only the G color value G33, the R and B color values R33 and B33 that cannot be detected in the current pixel are interpolated using the neighboring pixels in one of the horizontal and vertical directions depending on the interpolating direction determined by the interpolating direction determination unit 340.

Assuming that the determined interpolating direction is horizontal, the upper and lower neighboring pixels of the current pixel detect an R color value, G(y,x) denotes the G color value detected from the current pixel (y, x) located in the yth row and the xth column, and that a denotes a weighting factor which is inversely proportional to the ES of the current pixel, then the R color value R(y,x) that cannot be detected in the current pixel can be interpolated as follows:

R(y,x)=G(y,x)+α×{(R(y−1,x)+R(y+1,x))/2−(G(y−1,x)+(G(y+1,x−1)+G(y+1,x+1))/2}/2 [Equation 7]

For example, referring to FIG. 10B, when the interpolating direction determined by the interpolating direction determination unit 340 is horizontal, and the left and right neighboring pixels of the current pixel are R pixels, the R color value R33 of the current pixel (3, 3) can be calculated as follows: R33=G33+α×{(R32+R34)/2−(G32+(G33+G35)/2}/2. In addition, in Equation 7, α denotes a weighting factor which is inversely proportional to the ES of the current pixel. As described in association with FIG. 6, the weighting factor a is provided so as to approximate the R color value to the G color value in a region having a large ES and to allow the R color value to be independent of the G color value in a region having a low ES.

In addition, assuming that the determined interpolating direction is horizontal, the upper and lower neighboring pixels of the current pixel detect a B color value, G(y,x) denotes a G color value detected from the current pixel (y, x) located in the yth row and the xth column, and that a denotes a weighting factor which is inversely proportional to the ES of the current pixel, the B color value B(y,x) that cannot be detected in the current pixel can be interpolated as follows:

B(y,x)=G(y,x)+α×{(B(y−1,x)+B(y+1,x))/2−(G(y−1,x)+(G(y+1,x−1)+G(y+1,x+1))/2}/2 [Equation 8]

For example, referring to FIG. 10C, assuming that the interpolating direction determined by the interpolating direction determination unit 340 is a horizontal direction, the left and right neighboring pixels of the current pixel are R pixels, and that the upper and lower neighboring pixels are B pixels, the B color value B33 of the current pixel can be calculated as follows: B33=G33+α×{(B23+B43)/2−(G23+(G42+G44))/2}/2.

In addition, assuming that the interpolating direction determined by the interpolating direction determination unit 340 is a vertical direction, the left and right neighboring pixels of the current pixel detect R color values, G(y,x) denotes a G color value detected from the current pixel (y, x) located in the yth row and the xth column, and that a denotes a weighting factor which is inversely proportional to the ES of the current pixel, the R color value R(y,x) that cannot be detected from the current pixel can be interpolated as follows:

R(y,x)=G(y,x)+α×{(R(y,x−1)+R(y,x+1))/2−(G(y,x−1)+(G(y−1,x+1)+G(y+1,x+1))/2)/2}. [Equation 9]

For example, referring to FIG. 10D, the R color value R33 of the current pixel can be calculated as follows. R33=G33+α×{(R32+R34)/2−(G32+(G24+G44)/2)/2}.

In addition, in the above case, the B color value of the current pixel can be interpolated as follows:

B(y,x)=G(y,x)+α×{(B(y−1,x)+B(y+1,x))/2−(G(y−1,x)+(G(y,x)+G(y+2,x))/2)/2}. [Equation 10]

For example, referring to FIG. 10E, the B color value B33 of the current pixel can be calculated as follows: B33=G33+α×{(B23+B43)/2−(G23+(G33+G53)/2)/2}.

Although, in FIGS. 10A to 10E, it is assumed that the current pixel is a G pixel which detects a G color value, the left and right neighboring pixels of the current pixel are R pixels, and the upper and lower neighboring pixels are B pixels, the R and B color values that cannot be detected in the current pixel may be interpolated according to the following equations in the determined interpolating direction when the left and right neighboring pixels are B pixels, and the upper and lower neighboring pixels are R pixels, as in the case where the G pixel (2, 2) which detects the G color value G22 is the current pixel.

Assuming that the interpolating direction is horizontal, the left and right neighboring pixels of the current pixel detect a B color value, G(y,x) denotes a G color value detected from the current pixel (y, x) located in the yth row and the xth column, and that a denotes a weighting factor which is inversely proportional to the ES of the current pixel, the B color value B(y,x) that cannot be detected in the current pixel can be calculated as follows:

B(y,x)=G(y,x)+α×{(B(y,x−1)+B(y,x+1))/2−(G(y,x−1)+(G(y,x)+G(y,x+2))/2}/2. [Equation 11]

In the above case, the R color value R(y,x) is calculated as follows:

R(y,x)=G(y,x)+α×{(R(y−1,x)+R(y+1,x))/2−(G(y−1,x)+(G(y+1,x−1)+G(y+1,x+1))/2}/2. [Equation 12]

Meanwhile, assuming that the interpolating direction is vertical, the left and right neighboring pixels of the current pixel detect a B color value, G(y,x) denotes a G color value detected from the current pixel (y, x) located in the yth row and the xth column, and that a denotes a weighting factor which is inversely proportional to the ES of the current pixel, the B color value B(y,x) that cannot be detected in the current pixel can be calculated as follows:

B(y,x)=G(y,x)+α×{(B(y,x−1)+B(y,x+1))/2(G(y,x−1)+(G(y−1,x+1)+G(y+1,x+1))/2)/2} [Equation 13]

In the above case, the R color value R(y,x) is calculated as follows:

R(y,x)=G(y,x)+α×{(R(y−1,x)+R(y+1,x))/2−(G(y−1,x)+(G(y,x)+G(y+2,x))/2)/2} [Equation 14]

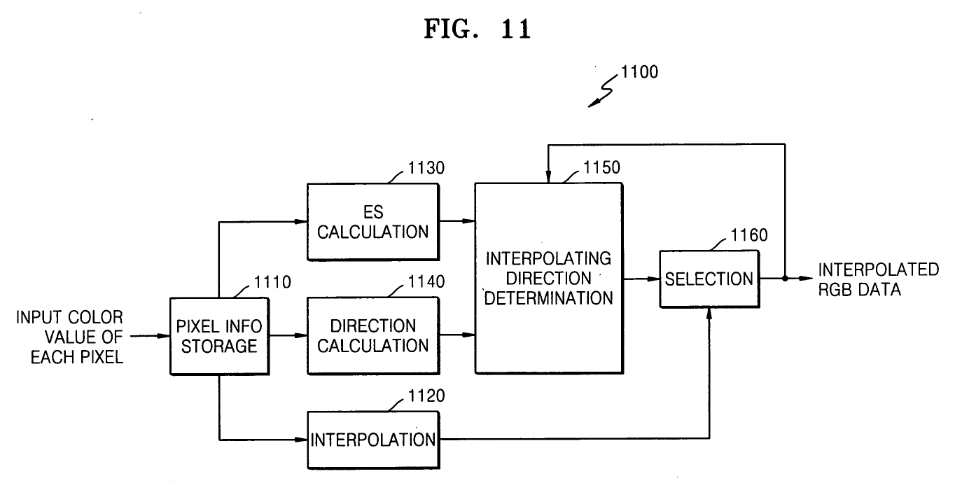

FIG. 11 is a block diagram illustrating an apparatus for interpolating a color value according to another exemplary embodiment.

The apparatus for interpolating a color value includes a pixel information storage unit 1110, an interpolation unit 1120, an edge strength calculation unit 1130, an interpolating direction determination unit 1150, and a selection unit 1160. The color interpolation apparatus 1100 generates a horizontal color interpolation candidate value and a vertical color interpolation candidate value using the neighboring pixels arranged in horizontal and vertical directions before the interpolating direction is determined. In other words, the horizontal and vertical color interpolation candidate values are calculated in vertical and horizontal directions according to the aforementioned interpolation method before the interpolating direction is determined.

Then, in a manner similar to the apparatus 300 illustrated in FIG. 3, the interpolating direction of the color value that cannot be detected in the current pixel is determined on the basis of the ES of the current pixel and the horizontal and vertical color value differences between the current pixel and the previously processed pixels, and the color interpolation candidate value corresponding to the determined interpolating direction is selected from the calculated color interpolation candidate values. Descriptions of a method of determining the interpolating direction and a process of calculating the horizontal and vertical color interpolation candidate values are similar to those provided in association with the aforementioned exemplary embodiment, and thus, detailed descriptions thereof are omitted.

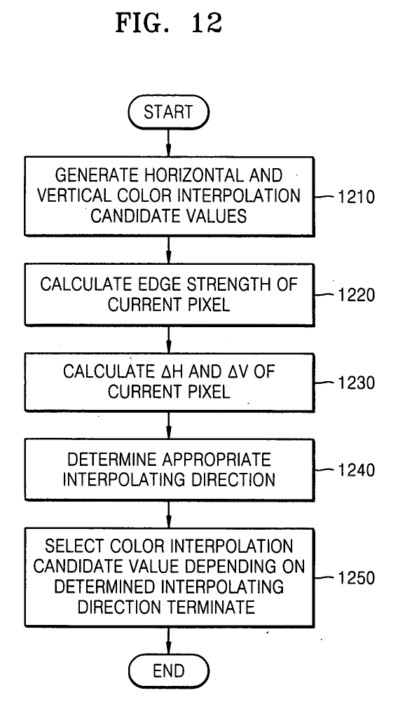

FIG. 12 is a flowchart illustrating a color interpolation method according to another exemplary embodiment of the present invention.

The horizontal and vertical color interpolation candidate values are generated by interpolating the color values that cannot be detected in the current pixel using the neighboring pixels arranged in the horizontal and vertical directions of the current pixel (operation 1210). The ES of the current pixel is calculated on the basis of the differences of the color values between the current pixel and the neighboring pixels (operation 1220). Then, the horizontal and vertical color value differences of the current pixel are calculated on the basis of the differences of the color values detected in the neighboring pixels arranged in the same row and column as those of the current pixel (operation 1230). The interpolating direction of the color value that cannot be detected in the current pixel is determined on the basis of the calculated ES of the current pixel and the horizontal and vertical color value differences between the current pixel and the previously processed pixels (operation 1240). A color interpolation candidate value interpolated in the selected interpolating direction is selected from the horizontal and vertical color interpolation candidate values as the interpolation value of the color value that cannot be detected in the current pixel (operation 1250).

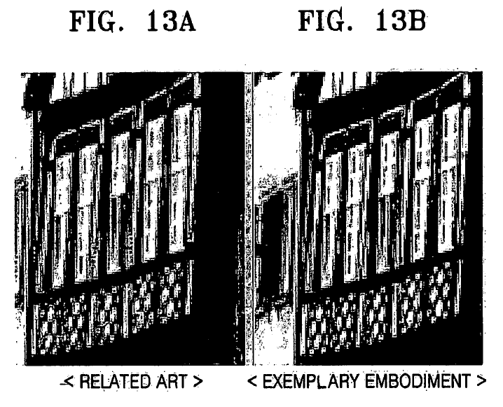

FIGS. 13A and 13B are photographs for comparing an image obtained by interpolating using a method of interpolating a color value according to an exemplary embodiment with an image obtained by interpolating using a related art method.

The method of interpolating a color value according to an exemplary embodiment may substantially reduce color errors that may occur in a horizontal or vertical edge region in an image and may more accurately perform color interpolation in comparison with the related art method.

Aspects of the present invention can also be embodied as computer readable codes on a computer readable recording medium. The computer readable recording medium is any data storage device that can store data which can be thereafter read by a computer system. Examples of the computer readable recording medium include but are not limited to read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

According to the exemplary embodiments, it may be possible to substantially reduce color errors that may occur in an edge region by calculating the edge strength (ES) with respect to the current pixel, determining the interpolating direction using the calculated ES, and by performing color interpolation in the determined interpolating direction. In addition, it may be possible to more accurately interpolate the color values that cannot be detected in the current pixel by using the edge information in the neighboring pixels. Furthermore, it is possible to simultaneously interpolate red, green, and blue (RGB) color values by performing interpolation using the value averaged in a horizontal or vertical direction based on the interpolating direction determined when the current pixel is interpolated. Therefore, it is possible to save memory capacity and improve processing speed.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A method of interpolating a color component that cannot be detected among a plurality of color components of each pixel, the method comprising:
calculating an edge strength of a current pixel on the basis of differences of color values between the current pixel and neighboring pixels;
calculating a horizontal color value difference and a vertical color value difference of the current pixel on the basis of differences of color values detected in the neighboring pixels arranged in a same row and a same column as those of the current pixel;
determining an interpolating direction of a color value that cannot be detected in the current pixel on the basis of the calculated edge strength of the current pixel and horizontal and vertical color value differences of the current pixel and previously processed pixels; and
interpolating the color value that cannot be detected in the current pixel in the determined interpolating direction using the neighboring pixels around the current pixel.

2. The method of claim 1, wherein the plurality of the color components includes red, green, and blue color components.

3. The method of claim 1, wherein the plurality of the color components includes luminance, blue chrominance, and red chrominance.

4. The method of claim 1, wherein the edge strength is calculated based on a weighted sum of differences between an absolute value of a green color value of the current pixel and an absolute value of the green color values detected in the neighboring pixels when the current pixel detects the green color value, and
wherein one of the edge strengths calculated for the neighboring pixels around the current pixel or an average of the edge strengths calculated for the neighboring pixels is used when the current pixel detects a red color value or a blue color value.

5. The method of claim 1, wherein, if the edge strength of the current pixel is equal to or smaller than a threshold value, the determining the interpolating direction further comprises:
determining the interpolating direction of the color value that cannot be detected in the current pixel as a vertical direction if the horizontal color value difference of the current pixel is larger than the vertical color value difference; and
determining the interpolating direction of the color value that cannot be detected in the current pixel as a horizontal direction if the vertical color value difference of the current pixel is larger than the horizontal color value difference.

6. The method of claim 1, wherein, if the edge strength of the current pixel is larger than a threshold value, the determining the interpolating direction of the color value that cannot be detected in the current pixel further comprises:
determining the interpolating direction of the color value that cannot be detected in the current pixel as a vertical direction if the number of previously processed pixels having a horizontal color value difference larger than the vertical color value difference is larger than a threshold value; and
determining the interpolating direction of the color value that cannot be detected in the current pixel as a horizontal direction if the number of previously processed pixels having a horizontal color value difference larger than the vertical color value difference is smaller than a threshold value.

7. The method of claim 1, wherein, if the edge strength of the current pixel is larger than a threshold value, the determining the interpolating direction of the color value that cannot be detected in the current pixel further comprises:
determining the interpolating direction of the color value that cannot be detected in the current pixel as a vertical direction if the number of previously processed pixels having a horizontal color value difference larger than the vertical color value difference is larger than a threshold value; and
performing spatial filtering for a value obtained by subtracting the vertical color value difference from the horizontal color value difference for the current pixel and each of the neighboring pixels and determining the interpolating direction of the color value that cannot be detected in the current pixel on the basis of the filtered value obtained by the spatial filtering if the number of previously processed pixels having a horizontal color value difference larger than the vertical color value difference is smaller than a threshold value.

8. The method of claim 7, wherein the spatial filtering is performed by averaging or low-pass filtering values obtained by subtracting the vertical color value difference from the horizontal color value difference of the current pixel and the neighboring pixels.

9. The method of claim 1, wherein, in the interpolating the color value that cannot be detected in the current pixel, a green color value that cannot be detected in the current pixel is interpolated by adding an average of the green color values detected in the neighboring pixels arranged in the same row as that of the current pixel to an average of differences between the color value detected in the current pixel and the color values of the same component detected in the neighboring pixels when the determined interpolating direction is horizontal, and the current pixel detects a red or blue color value.

10. The method of claim 1, wherein, in the interpolating the color value that cannot be detected in the current pixel, a green color value that cannot be detected in the current pixel is interpolated by adding an average of the green color values detected in the neighboring pixels arranged in the same column as that of the current pixel to an average of differences between the color value detected in the current pixel and the color values of the same component detected in the neighboring pixels when the determined interpolating direction is vertical, and the current pixel detects a red or blue color value.

11. The method of claim 1, wherein, in the interpolating the color value that cannot be detected in the current pixel, a blue color value is interpolated by adding a green color value interpolated for the current pixel to an average of differences between blue color values detected in four neighboring pixels arranged in diagonal directions of the current pixel and green color values interpolated for the neighboring pixels when the current pixel detects a red color value.

12. The method of claim 1, wherein, in the interpolating the color value that cannot be detected in the current pixel, a red color value that cannot be detected in the current pixel is interpolated by adding a green color value interpolated for the current pixel to an average of differences between red color values detected in neighboring pixels arranged in diagonal directions of the current pixel and green color values interpolated for the neighboring pixels when the current pixel detects a blue color value.

13. The method of claim 1, wherein, in the interpolating the color value that cannot be detected in the current pixel, a red color value R(y,x) that cannot be detected in the current pixel is interpolated as follows:
R(y,x)=G(y,x)+α×{(R(y,x−1)+R(y,x+1))/2−(G(y,x−1)+(G(y,x)+G(y,x+2))/2}/2
where, the determined interpolating direction is horizontal, the left and right neighboring pixels of the current pixel detect red color values, G(y,x) denotes a green color value detected in the current pixel (y, x) located in the yth row and the xth column, and α denotes a weighting factor which is inversely proportional to an edge strength of the current pixel.

14. The method of claim 1, wherein, in the interpolating the color value that cannot be detected in the current pixel, a blue color value B(y,x) that cannot be detected in the current pixel is interpolated as follows:
B(y,x)=G(y,x)+α×{(B(y,x−1)+B(y,x+1))/2−(G(y,x−1)+(G(y,x)+G(y,x+2))/2}/2
where, the determined interpolating direction is horizontal, the left and right neighboring pixels of the current pixel detect blue color values, G(y,x) denotes a green color value detected in the current pixel (y, x) located in the yth row and the xth column, and α denotes a weighting factor which is inversely proportional to an edge strength of the current pixel.

15. The method of claim 1, wherein, in the interpolating the color value that cannot be detected in the current pixel, a red color value R(y,x) that cannot be detected in the current pixel is interpolated as follows:
R(y,x)=G(y,x)+α×{(R(y−1,x)+R(y+1,x))/2−(G(y−1,x)+(G(y+1,x−1)+G(y+1,x+1))/2}/2
where, the determined interpolating direction is horizontal, the upper and lower neighboring pixels of the current pixel detect a red color value, G(y,x) denotes a green color value detected in the current pixel (y, x) located in the yth row and the xth column, and α denotes a weighting factor which is inversely proportional to an edge strength of the current pixel.

16. The method of claim 1, wherein, in the interpolating the color value that cannot be detected in the current pixel, a blue color value B(y,x) that cannot be detected in the current pixel is interpolated as follows:
B(y,x)=G(y,x)+α×{(B(y−1,x)+B(y+1,x))/2−(G(y−1,x)+(G(y+1,x−1)+G(y+1,x+1))/2}/2
where, the determined interpolating direction is horizontal, the upper and lower neighboring pixels of the current pixel detect a blue color value, G(y,x) denotes a green color value detected in the current pixel (y, x) located in the yth row and the xth column, and α denotes a weighting factor which is inversely proportional to an edge strength of the current pixel.

17. The method of claim 1, wherein, in the interpolating the color value that cannot be detected in the current pixel, a red color value R(y,x) that cannot be detected in the current pixel is interpolated as follows:
R(y,x)=G(y,x)+α×{(R(y,x−1)+R(y,x+1))/2−(G(y,x−1)+(G(y−1,x+1)+G(y+1,x+1))/2)/2}
where, the determined interpolating direction is vertical, the left and right neighboring pixels of the current pixel detect a red color value, G(y,x) denotes a green color value detected in the current pixel (y, x) located in the yth row and the xth column, and α denotes a weighting factor which is inversely proportional to an edge strength of the current pixel.

18. The method of claim 1, wherein, in the interpolating the color value that cannot be detected in the current pixel, a blue color value B(y,x) that cannot be detected in the current pixel is interpolated as follows:
B(y,x)=G(y,x)+α×{(B(y,x−1)+B(y,x+1))/2−(G(y,x−1)+(G(y−1,x+1)+G(y+1,x+1))/2)/2}
where, the determined interpolating direction is vertical, the left and right neighboring pixels of the current pixel detect a blue color value, G(y,x) denotes a green color value detected in the current pixel (y, x) located in the yth row and the xth column, and α denotes a weighting factor which is inversely proportional to an edge strength of the current pixel.

19. The method of claim 1, wherein, in the interpolating the color value that cannot be detected in the current pixel, a blue color value B(y,x) that cannot be detected in the current pixel is interpolated as follows:
B(y,x)=G(y,x)+α×{(B(y−1,x)+B(y+1,x))/2−(G(y−1,x)+(G(y,x)+G(y+2,x))/2)/2}
where, the determined interpolating direction is vertical, the neighboring upper and lower pixels of the current pixel detect a blue color value, G(y,x) denotes a green color value detected in the current pixel (y, x) located in the yth row and the xth column, and α denotes a weighting factor which is inversely proportional to an edge strength of the current pixel.

20. The method of claim 1, wherein, in the interpolating the color value that cannot be detected in the current pixel, a red color value R(y,x) that cannot be detected in the current pixel is interpolated as follows:
R(y,x)=G(y,x)+α×{(R(y−1,x)+R(y+1,x))/2−(G(y−1,x)+(G(y,x)+G(y+2,x))/2)/2}
where, the determined interpolating direction is vertical, the upper and lower neighboring pixels of the current pixel detect a red color value, G(y,x) denotes a green color value detected in the current pixel (y, x) located in the yth row and the xth column, and α denotes a weighting factor which is inversely proportional to an edge strength of the current pixel.

21. A method of interpolating a color component that cannot be detected among a plurality of color components of each pixel, the method comprising:
generating a horizontal color interpolation candidate value and a vertical color interpolation candidate value by interpolating a color value that cannot be detected in a current pixel by using neighboring pixels arranged in a horizontal direction and a vertical direction of the current pixel;
calculating an edge strength of the current pixel based on differences of color values between the current pixel and the neighboring pixels;
calculating a horizontal color value difference and a vertical color value difference of the current pixel based on differences of color values detected in the neighboring pixels arranged in a same row and a same column as those of the current pixel;
determining an interpolating direction of a color value that cannot be detected in the current pixel on the basis of the calculated edge strength of the current pixel and horizontal and vertical color value differences of the current pixel and previously processed pixels; and
selecting a color interpolation candidate value interpolated in the determined interpolating direction from the horizontal and vertical color interpolation candidate values as an interpolation value of the color that cannot be detected in the current pixel.

22. An apparatus for interpolating a color component that cannot be detected among a plurality of color components of each pixel, the apparatus comprising:
an edge strength calculation unit that calculates an edge strength of a current pixel on the basis of differences of color values between the current pixel and neighboring pixels around the current pixel;
a direction calculation unit that calculates a horizontal color value difference and a vertical color value difference of the current pixel based on the differences of color values detected in the pixels arranged in a same row and a same column as those of the current pixel;
an interpolating direction determination unit determining an interpolating direction of the color value that cannot be detected in the current pixel on the basis of the calculated edge strength of the current pixel and the horizontal and vertical color value differences of the current pixel and previously processed pixels; and
an interpolation unit interpolating the color value that cannot be detected in the current pixel in the determined interpolating direction using the neighboring pixels around the current pixel.

23. The apparatus of claim 22, wherein the plurality of color components include red, green, and blue color components.

24. The apparatus of claim 22, wherein the plurality of color components include luminance, blue chrominance, and red chrominance.

25. The apparatus of claim 22, wherein the edge strength calculation unit uses a weighted sum of differences between an absolute value of a green color value of the current pixel and an absolute value of green color values detected in the neighboring pixels when the current pixel detects the green color value, and wherein the edge strength calculation unit uses one of the edge strengths calculated for the neighboring pixels around the current pixel or an average of the edge strengths calculated for the neighboring pixels when the current pixel detects a red or blue color value.

26. The apparatus of claim 22, wherein, if the edge strength of the current pixel is equal to or smaller than a threshold value, the interpolating direction determination unit determines the interpolating direction of the color value that cannot be detected in the current pixel as a vertical direction if the horizontal color value difference of the current pixel is larger that the vertical color value difference, and the interpolating direction determination unit determines the interpolating direction of the color value that cannot be detected in the current pixel as a horizontal direction if the vertical color value difference of the current pixel is larger that the horizontal color value difference.

27. The apparatus of claim 22, wherein, if the edge strength of the current pixel is larger than a first threshold value, the interpolating direction determination unit determines the interpolating direction of the color value that cannot be detected in the current pixel as a vertical direction if the number of previously processed pixels having a horizontal color value difference larger than the vertical color value difference is larger than a second threshold value, and the interpolating direction determination unit determines the interpolating direction of the color value that cannot be detected in the current pixel as a horizontal direction if the number of previously processed pixels having a horizontal color value difference larger than the vertical color value difference is smaller than the second threshold value.

28. The apparatus of claim 22, wherein, if the edge strength of the current pixel is larger than a first threshold value, the interpolating direction determination unit determines the interpolating direction of the color value that cannot be detected in the current pixel as a vertical direction if the number of previously processed pixels having a horizontal color value difference larger than the vertical color value difference is larger than a second threshold value; and the interpolating direction determination performs spatial filtering for a value obtained by subtracting the vertical color value difference from the horizontal color difference of the current pixel and the neighboring pixels and determines the interpolating direction of the color value that cannot be detected in the current pixel on the basis of the value obtained by the spatial filtering if the number of previously processed pixels having a horizontal color value difference larger than the vertical color value difference is smaller than the second threshold value.

29. The apparatus of claim 28, wherein the spatial filtering is performed by averaging or low-pass filtering values obtained by subtracting the vertical color value difference from the horizontal color value difference of the current pixel and the neighboring pixels.

30. The apparatus of claim 22, wherein the interpolation unit interpolates a green color value that cannot be detected in the current pixel by adding an average of the green color values detected in the neighboring pixels arranged in the same row as that of the current pixel to an average of differences between the color value detected in the current pixel and the color values of the same component detected in the neighboring pixels when the determined interpolating direction is horizontal, and the current pixel detects a red or blue color value.

31. The apparatus of claim 22, wherein an interpolation unit interpolates a green color value that cannot be detected in the current pixel by adding an average of the green color values detected in the neighboring pixels arranged in the same column as that of the current pixel to an average of differences between the color value detected in the current pixel and the color values of the same component detected in the neighboring pixels when the determined interpolating direction is vertical, and the current pixel detects a red or blue color value.

32. The apparatus of claim 22, wherein the interpolation unit interpolates a blue color value by adding a green color value interpolated for the current pixel to an average of differences between blue color values detected in four neighboring pixels arranged in diagonal directions of the current pixel and green color values interpolated for the neighboring pixels when the current pixel detects a red color value.

33. The apparatus of claim 22, wherein the interpolation unit interpolates a red color value that cannot be detected in the current pixel by adding a green color value interpolated for the current pixel to an average of differences between red color values detected in neighboring pixels arranged in diagonal directions of the current pixel and green color values interpolated for the neighboring pixels when the current pixel detects a blue color value.

34. The apparatus of claim 22, wherein the interpolation unit interpolates a red color value R(y,x) that cannot be detected in the current pixel as follows:
R(y,x)=G(y,x)+α×{(R(y,x−1)+R(y,x+1))/2−(G(y,x−1)+(G(y,x)+G(y,x+2))/2}/2
where, the determined interpolating direction is horizontal, the left and right neighboring pixels of the current pixel detect red color values, G(y,x) denotes a green color value detected in the current pixel (y, x) located in the yth row and the xth column, and α denotes a weighting factor which is inversely proportional to an edge strength of the current pixel.

35. The apparatus of claim 22, wherein the interpolation unit interpolates a blue color value B(y,x) that cannot be detected in the current pixel as follows:
B(y,x)=G(y,x)+α×{(B(y,x−1)+B(y,x+1))/2−(G(y,x−1)+(G(y,x)+G(y,x+2))/2}/2
where, the determined interpolating direction is horizontal, the left and right neighboring pixels of the current pixel detect blue color values, G(y,x) denotes a green color value detected in the current pixel (y, x) located in the yth row and the xth column, and α denotes a weighting factor which is inversely proportional to an edge strength of the current pixel.

36. The apparatus of claim 22, wherein the interpolation unit interpolates a red color value R(y,x) that cannot be detected in the current pixel is interpolated as follows:
R(y,x)=G(y,x)+α×{(R(y−1,x)+R(y+1,x))/2−(G(y−1,x)+(G(y+1,x−1)+G(y+1,x+1))/2}/2
where, the determined interpolating direction is horizontal, the upper and lower neighboring pixels of the current pixel detect a red color value, G(y,x) denotes a green color value detected in the current pixel (y, x) located in the yth row and the xth column, and α denotes a weighting factor which is inversely proportional to an edge strength of the current pixel.

37. The apparatus of claim 22, wherein the interpolation unit interpolates a blue color value B(y,x) that cannot be detected in the current pixel as follows:
B(y,x)=G(y,x)+α×{(B(y−1,x)+B(y+1,x))/2−(G(y−1,x)+(G(y+1,x−1)+G(y+1,x+1))/2}/2
where, the determined interpolating direction is horizontal, the upper and lower neighboring pixels of the current pixel detect a blue color value, G(y,x) denotes a green color value detected in the current pixel (y, x) located in the yth row and the xth column, and α denotes a weighting factor which is inversely proportional to an edge strength of the current pixel.

38. The apparatus of claim 22, wherein the interpolation unit interpolates a red color value R(y,x) that cannot be detected in the current pixel is interpolated as follows:
R(y,x)=G(y,x)+α×{(R(y,x−1)+R(y,x+1))/2−(G(y,x−1)+(G(y−1,x+1)+G(y+1,x+1))/2)/2}
where, the determined interpolating direction is vertical, the left and right neighboring pixels of the current pixel detect a red color value, G(y,x) denotes a green color value detected in the current pixel (y, x) located in the yth row and the xth column, and α denotes a weighting factor which is inversely proportional to an edge strength of the current pixel.

39. The apparatus of claim 22, wherein the interpolation unit interpolates a blue color value B(y,x) that cannot be detected in the current pixel as follows:
B(y,x)=G(y,x)+α×{(B(y,x−1)+B(y,x+1))/2−(G(y,x−1)+(G(y−1,x+1)+G(y+1,x+1))/2)/2}
where, the determined interpolating direction is vertical, the left and right neighboring pixels of the current pixel detect a blue color value, G(y,x) denotes a green color value detected in the current pixel (y, x) located in the yth row and the xth column, and α denotes a weighting factor which is inversely proportional to an edge strength of the current pixel.

40. The apparatus of claim 22, wherein the interpolation unit interpolates a blue color value B(y,x) that cannot be detected in the current pixel as follows:
B(y,x)=G(y,x)+α×{(B(y−1,x)+B(y+1,x))/2−(G(y−1,x)+(G(y,x)+G(y+2,x))/2)/2}
where the determined interpolating direction is vertical, the upper and lower neighboring pixels of the current pixel detect a blue color value, G(y,x) denotes a green color value detected in the current pixel (y, x) located in the yth row and the xth column, and α denotes a weighting factor which is inversely proportional to an edge strength of the current pixel.

41. The apparatus of claim 22, wherein the interpolation unit interpolates a red color value R(y,x) that cannot be detected in the current pixel as follows:
R(y,x)=G(y,x)+α×{(R(y−1,x)+R(y+1,x))/2−(G(y−1,x)+(G(y,x)+G(y+2,x))/2)/2}
where, the determined interpolating direction is vertical, the upper and lower neighboring pixels of the current pixel detect a red color value, G(y,x) denotes a green color value detected in the current pixel (y, x) located in the yth row and the xth column, and α denotes a weighting factor which is inversely proportional to an edge strength of the current pixel.

42. An apparatus for interpolating a color component that cannot be detected among a plurality of color components of each pixel, the apparatus comprising:
a color interpolation candidate value generation unit that generates a horizontal color interpolation candidate value and a vertical color interpolation candidate value by interpolating a color value that cannot be detected in a current pixel by using neighboring pixels arranged in horizontal and vertical directions of the current pixel;
an edge strength calculation unit that calculates an edge strength of the current pixel on the basis of differences of color values between the current pixel and the neighboring pixels;
a calculation unit that calculates a horizontal color value difference and a vertical color value difference of the current pixel on the basis of differences of color values detected in the neighboring pixels arranged in the same row and column as those of the current pixel;
an interpolating direction determination unit that determines an interpolating direction of the color value that cannot be detected in the current pixel on the basis of the calculated edge strength of the current pixel and horizontal and vertical color value differences of the current pixel and previously processed pixels; and
a selection unit that selects a color interpolation candidate value interpolated in the determined interpolating direction between the horizontal and vertical color interpolation candidate values as an interpolation value of the color value that cannot be detected in the current pixel.

43. A computer readable medium having instructions including a method of interpolating a color component that cannot be detected among a plurality of color components of each pixel, the method comprising:
calculating an edge strength of a current pixel on the basis of differences of color values between the current pixel and neighboring pixels;
calculating a horizontal color value difference and a vertical color value difference of the current pixel on the basis of differences of color values detected in the neighboring pixels arranged in a same row and a same column as those of the current pixel;
determining an interpolating direction of a color value that cannot be detected in the current pixel on the basis of the calculated edge strength of the current pixel and horizontal and vertical color value differences of the current pixel and previously processed pixels; and
interpolating the color value that cannot be detected in the current pixel in the determined interpolating direction using the neighboring pixels around the current pixel.

44. A computer readable medium having instructions including a method of interpolating a color component that cannot be detected among a plurality of color components of each pixel, the method comprising:
generating a horizontal color interpolation candidate value and a vertical color interpolation candidate value by interpolating a color value that cannot be detected in a current pixel by using neighboring pixels arranged in a horizontal direction and a vertical direction of the current pixel;
calculating an edge strength of the current pixel based on differences of color values between the current pixel and the neighboring pixels;
calculating a horizontal color value difference and a vertical color value difference of the current pixel based on differences of color values detected in the neighboring pixels arranged in a same row and a same column as those of the current pixel;
determining an interpolating direction of a color value that cannot be detected in the current pixel on the basis of the calculated edge strength of the current pixel and horizontal and vertical color value differences of the current pixel and previously processed pixels; and
selecting a color interpolation candidate value interpolated in the determined interpolating direction from the horizontal and vertical color interpolation candidate values as an interpolation value of the color that cannot be detected in the current pixel.
